(19) United States
(12) Patent Application Publication
(10) Pub. No.: US 2015/0353398 A1
(43) Pub. Date: Dec. 10, 2015

(54) SYSTEM FOR WASTEWATER TREATMENT USING AQUATIC PLANTS

(71) Applicant: Leon A. Lassovsky, Sevilla (ES)

(72) Inventor: Leon A. Lassovsky, Sevilla (ES)

(21) Appl. No.: 14/761,422

(22) PCT Filed: Jan. 21, 2014
(86) PCT No.: PCT/US2014/012259

§ 371 Date: Jul. 16, 2015

Related U.S. Application Data
(60) Provisional application No. 61/859,530, filed on Jul. 29, 2013.
(60) Provisional application No. 61/754,742, filed on Jan. 21, 2013.
(60) Provisional application No. 61/822,610, filed on May 13, 2013.

(51) Int. Cl. C02F 3/32; C02F 3/10

(52) U.S. Cl. CPC C02F 3/327; C02F 3/101

(57) ABSTRACT

A wastewater treatment system includes a treatment zone having wastewater therein, the zone having multiple depths connected by slopes. Buoyant support structures are disposed in the treatment zone and receive aquatic plants. Hydraulic curtain assemblies are disposed in the treatment zone and define lanes in the wastewater environment. Biological curtains are connected to the support structures and have a body or material for formation of biofilms.

### FIELD OF THE INVENTION

The present invention relates generally to the treatment of wastewater and, more specifically, to the treatment of wastewater using aquatic plants supported by support structures in a wastewater environment.

### BACKGROUND OF THE INVENTION

State-of-the-art wastewater treating operations work in three stages. In the first stage solid waste materials are separated from the water and in the other two stages oxygen is injected into wastewater for bacteria to metabolize the waste therein. These two latter stages require technologies that are expensive to install, difficult to maintain and expensive to operate because they are complicated and energy intensive. To combat the rising energy costs associated with conventional wastewater treatment, “Wetland” treatment technologies have been applying the inherent ability of aquatic macrophyte plants to oxygenate their immediate aqueous environment stimulating the metabolism of waste-consuming bacteria to do the same work as they do in conventional facilities using nothing more than the sun's energy and a little wind. These technologies capitalize on this simple and “free” phenomenon to treat wastewater with the same efficacy as conventional wastewater treatment facilities with virtually no operating costs. However, “Wetland” projects have several significant drawbacks since they require very large tracts of land and the porous substances making up the filters of the treatment ponds may become saturated or clogged with unprocessed waste requiring their replacement or prolonged recycle times for the entire facility. More importantly, these projects have no way to regulate the amount of time wastewater is exposed to waste consuming bacteria in an oxygenated environment, and, at times such as after an intense rain storm, can let insufficiently treated effluent pass through the facility.

Research related to “Wetland” treatment processes has been found emergent macrophyte varieties are extremely efficient in transmitting the air from the wind flowing through their canopies to their roots and rhizomes making them ideal for oxygenating wastewater. These plants have been found to naturally form “mats” on the surface of water and that these formations injected very large amounts of oxygen into the water without establishing roots in the sediments. In nature these “mats” form when individual groups of plants break away from the plant colonies near the shores and float on the surface because of the gas spaces in their rhizomes and the decomposing dead plants in the mat. Thus, amongst the patents related to the formation of “floating mats”, U.S. Pat. Nos. 5,799,440; 6,322,699; 7,776,261; and 8,250,808 stand out as providing the means of emulating a process that occurs in nature. These approaches to the formation of “mats” usually establish a certain amount of young plants upon floating devices and let them reproduce till a “floating mat” is formed. Although this approach requires much less space than conventional “Wetland” projects do, because they create very dense “mats” some wastewater usually flows underneath these without being evenly exposed to the waste-consuming bacteria.

### SUMMARY OF THE INVENTION

The present invention provides various embodiments of systems and methods for the treatment of wastewater using aquatic plants.

In one embodiment, a system for wastewater treatment using aquatic plants in a wastewater environment having an inlet and an outlet. A wastewater treatment zone extends between an inlet and an outlet, the treatment zone having wastewater disposed therein and flowing into the treatment zone from the inlet and out of the treatment zone from the outlet. The wastewater treatment zone has a first end and an opposed second end with a floor extending between the first and second ends. A depth is defined from a surface of the wastewater to the floor, and the treatment zone has a plurality of depth zones continuous with one another. These zones include at least a deep zone and a shallow zone. The deep zone is adjacent the first end of the treatment zone and has a first depth. The shallow zone is adjacent the second end of the treatment zone and has a second depth less than the first depth. A portion of the floor of the treatment zone between the deep zone and the shallow zone slopes upwardly at an angle of at least 45 degrees. A plurality of buoyant support structures are disposed in the treatment zone for supporting aquatic plants in the wastewater environment. Each support structure includes a plurality of first stage members each having a buoyancy chamber defined therein, the first stage members defining a lower portion of the support structure and being spaced apart from one another. Each support structure also includes a plurality of elongated cross members disposed on top of the first stage members, the cross members extending between and interconnecting the first stage members, with each cross member having a plurality of openings defined therein for receiving plants. A plurality of hydraulic curtain assemblies each include a hydraulic curtain with an upper end and a lower part extending downwardly therefrom to a lower end. The assemblies each further include a floatation element connected to the upper end of the hydraulic curtain. The hydraulic curtain assemblies are disposed in the treatment zone such that the hydraulic curtains define a plurality of lanes in the wastewater environment. A plurality of biological curtains are each connected to one of the buoyant support structures, the biological curtain members comprising a body of material for formation of biofilms. The biological curtain members extend downwardly from the buoyant support structures into the lanes of the wastewater environment. A first plurality of aquatic plants is disposed each disposed in one of the openings in the cross members, the plants being selected from the group of categories consisting of emergent macrophytes, floating leaf macrophytes, and submerged leaf macrophytes.

In some versions, the depth zones further include a medium zone disposed between the deep and shallow zones, the medium zone having a third depth greater than the second depth and less than the first depth. The floor of the treatment zone between the deep zone and the medium zone slopes upwardly at an angle of at least 45 degrees and the floor of the treatment zone between the medium zone and the shallow zone slopes upwardly at an angle of at least 45 degrees.

In some versions, the buoyant support structures each further include at least one third stage member disposed above the first stage members, the at least one third stage member having a buoyancy chamber defined therein. The first and third stage members may be elongated generally tubular hollow members. The first stage members may be disposed generally parallel to each other, with the elongated cross members being disposed generally parallel to each other and generally perpendicular to the first stage members.

In some versions, the elongated cross members each have a pair of elongated tubular side elements with a web extending therebetween, the openings for receiving plants being defined in the web, the tubular side elements each defining a buoyancy chamber.

In some versions, the hydraulic curtain assemblies extend side to side in the treatment zone, some of the hydraulic curtain assemblies extending from a first side of the treatment zone part way to a second side and some of the hydraulic curtain assemblies extending from the second side part way to the first side such that the hydraulic curtains define a plurality of back and forth lanes.

In some versions, the biological curtains and hydraulic curtains are sheets of the same material. The material is a non-woven mesh.

In some versions, the biological curtains extend generally parallel to the hydraulic curtains, and in other versions the biological curtains extend generally perpendicular to the hydraulic curtains.

In some versions, the buoyant support structures are configured such that the elongated cross members, with the plants disposed in the openings therein, are disposed approximately at an upper surface of the wastewater environment.

Some versions further include plant holders received in the openings in the cross members, the plants being disposed in the plant holders.

In some versions, the floatation element of at least some of the hydraulic curtain assemblies is one of the buoyant support structures.

In another embodiment, a system is provided for use in a wastewater environment having an inlet, an outlet, and a treatment zone extending between the inlet and outlet. Wastewater is disposed in the treatment zone and flows into the treatment zone from the inlet and out of the treatment zone from the outlet. The system includes an outlet barrier for controlling a flow of wastewater from a treatment zone to an outlet from the wastewater environment. The outlet barrier structure includes a base having a lower portion disposed on a bottom of the wastewater environment adjacent the outlet and a guide portion extending upwardly therefrom. The base has negative buoyancy. An upper portion movably engages the guide portion of the base and has a top edge. The upper portion has adjustable buoyancy such that a position of the upper portion relative to an upper surface of the wastewater at the outlet may be adjusted by adjusting the buoyancy of the upper portion. The system also includes at least one immersed support structure with adjustable buoyancy for supporting aquatic plants in the wastewater environment. The support structure is disposed in the wastewater in the treatment zone and includes a support frame and a plurality of plant holders. Each plant holder has a plant receiving area and is interconnected with the support frame such that some of the plant holders are disposed at a first vertical position and others of the plant holders are disposed at a second vertical position. The support structure has adjustable buoyancy such that a position of the support structure relative to the upper surface of the wastewater in the treatment zone may be adjusted by adjusting the buoyancy of the support structure. As such, some of the plant holders are positioned at a first depth and others of the plant holders are disposed at a second depth with respect to the upper surface of the wastewater.

In some versions, the support structure has an upper region and a lower region and a buoyancy chamber defined in the support structure. An air inlet is in fluid communication with the buoyancy chamber such that air is injected through the air inlet to increase the buoyancy of the support structure. The air inlet may be disposed in the upper region of the support structure and the support structure may further have a water outlet in the lower region. In this version, the water outlet is in fluid communication with the buoyancy chamber such that as air is injected into the buoyancy chamber, water is displaced through the water outlet; and as air is removed from the buoyancy chamber, water flows into the buoyancy chamber from the water outlet.

In another version, the air inlet is an opening in the lower region of the support structure and the opening is in fluid communication with the buoyancy chamber such that as air is injected into the buoyancy chamber, water is displaced through the opening; and as air is removed from the buoyancy chamber, water flows into the buoyancy chamber from the opening.

In some versions, the support structure has a liquid inlet, a plurality of liquid outlets, and a liquid passage connecting the liquid inlet with the plurality of liquid outlets. The liquid outlets are located such that liquid provided through the liquid inlet is distributed through the plurality of outlets to the wastewater environment. The support structure may have a buoyancy chamber defined therein with the chamber defining part of the liquid passage such that liquid provided through the liquid inlet flows through the buoyancy chamber. The support structure may further have an air supply tube or an air valve in fluid communication with the buoyancy chamber for adjusting a quantity of air in the buoyancy chamber and thereby adjusting the buoyancy of the support structure.

In some versions, the system includes at least a second support structure for supporting aquatic plants in the wastewater environment. The support structure includes four elongated support members interconnected to form a generally rectangular perimeter. A plurality of plant holders are interconnected with the support members, and each plant holder has a plant receiving area.

In some versions, the system includes a first plurality of aquatic plants disposed on some of the plant supports and a second plurality of aquatic plants disposed on others of the plant supports. The first plurality and second plurality of aquatic plants are different categories of aquatic plants, with the categories being selected from the group of categories consisting of emergent macrophytes, floating leaf macrophytes, and submerged leaf macrophytes.

In some versions, the system further includes an inlet barrier structure for controlling a flow of water into the treatment zone. The inlet barrier structure includes a base having a lower portion disposed on a bottom of the wastewater environment adjacent the inlet and a guide portion extending upwardly therefrom. The base has negative buoyancy. An upper portion is movably engaged with the guide portion of the base. The upper portion has a top edge. The upper portion has adjustable buoyancy such that a position of the upper portion relative to an upper surface of the wastewater at the inlet may be adjusted by adjusting the buoyancy of the upper portion. The inlet barrier system may include a skimmer element interconnected with the upper portion and spaced from the top edge. The skimmer element may be disposed at the upper surface of the wastewater. The upper portions of the inlet and outlet barrier structures may each have a buoyancy chamber defined therein and an air inlet in fluid communication with the buoyancy chamber. The buoyancy of the upper portions may be adjusted by adjusting the quantity of air in the buoyancy chambers. The barrier structures may each further include a motor operable to move the upper portion relative to the base.

In some versions, a skirt element is interconnected with the support structure and extends downwardly therefrom. The skirt element defines a barrier for directing the flow of wastewater relative to the support structure.

In some versions, the system further includes an anchoring system for maintaining a position of the support structure. The anchoring system includes a plurality of anchoring elements each including a foot disposed on the bottom of the treatment zone and a post extending upwardly therefrom. The support structure includes a plurality of guides attached thereto. The guides each slidably receive a post such that the support structure slides upwardly and downwardly on the posts as the level of wastewater changes.

In some versions, the barrier structure further includes a pair of lateral supports disposed at opposite ends of the upper portion and extending downwardly to the bottom.

A further embodiment of the present invention provides a system for wastewater treatment using aquatic plants in a wastewater environment having an inlet, an outlet, and a treatment zone extending between the inlet and outlet. Wastewater is disposed in the treatment zone and flows into the treatment zone from the inlet and out of the treatment zone from the outlet. The system includes a plurality of immersed adjustably buoyant support structures for supporting aquatic plants in the wastewater environment. Each structure is disposed in the wastewater in the treatment zone. Each support structure includes a support frame having a buoyancy chamber defined therein. An air inlet is in fluid communication with the buoyancy chamber for adjusting the quantity of air in the buoyancy chamber, thereby adjusting the buoyancy of the support structure. A plurality of plant holders each have a plant receiving area and are interconnected with the support frame. The system further includes a plurality of skirt elements each comprising a barrier with an upper end and a lower part extending downwardly towards a bottom of the treatment zone such that a flow of wastewater is redirected by each skirt element. A first plurality of aquatic plants is disposed on some of the plant supports, with the plants being selected from the group of categories consisting of emergent macrophytes, floating leaf macrophytes, and submerged leaf macrophytes. The buoyancy of the support structures is adjusted such that each support structure is submerged in the wastewater and the support structure and plants are neutrally buoyant in the wastewater in the treatment zone.

In some versions, the system further includes an outlet barrier structure for controlling the flow of wastewater from a treatment zone to an outlet. The outlet barrier structure includes a base having a lower portion disposed on a bottom of the wastewater environment adjacent the outlet and a guide portion extending upwardly therefrom. The base has negative buoyancy. An upper portion is movably engaged with the guide portion of the base. The upper portion has a top edge. The upper portion has adjustable buoyancy such that a position of the upper portion relative to the upper surface of the wastewater at the outlet may be adjusted by adjusting the buoyancy of the upper portion.

In some versions, the buoyancy of the support structures is adjusted such that some of the support structures are disposed at a first position relative to an upper surface of the wastewater and others of the support structures are disposed at a second position relative to the upper surface of the wastewater. The system further includes a second plurality of aquatic plants, the second plurality of aquatic plants being a different category of plant from the first plurality of plants. The system further includes an anchoring system for maintaining a position of each support structure. The anchoring system includes a plurality of anchoring elements each including a foot disposed on the bottom of the treatment zone and a post extending upwardly therefrom. The support structures each further include a plurality of guides attached thereto. The guides each slidably receive a post such that the support structures slide upwardly and downwardly on the post as the level of wastewater changes. Some of the plants supported by the holders are positioned at a first depth and others of the plants are disposed at a second depth with respect to the upper surface of the wastewater.

The present invention also provides a method of wastewater treatment using aquatic plants. The method provides a plurality of support structures each having support elements and a plurality of plant holders interconnected with the support elements. The plant holders each have a plant receiving area. The plurality of support structures include at least a first group of support structures and a second group of support structures. A first plurality of aquatic plants are provided and disposed on plant holders of the first group of the support structures. A second plurality of aquatic plants is provided and the bases of the plants are disposed on plant holders of the second group of the support structures. The first plurality and second plurality of aquatic plants are different categories of aquatic plants. The categories are selected from the group of categories consisting of emergent macrophytes, floating leaf macrophytes, and submerged leaf macrophytes. The support structures are disposed in the wastewater environment. The buoyancy of the support structures is adjusted such that each support structure with its respective plants has a generally neutral buoyancy and is immersed in the wastewater environment. The buoyancy being adjusted such that the first group of support structures is at a first depth with respect to the upper surface and the second group of support structures is at a second depth with respect to the upper surface. As such, the first plurality of aquatic plants are adjacent the surface of the wastewater environment and the bases of the second plurality of aquatic plants are submerged.

In some versions, each support structure includes a buoyancy chamber and an air inlet in fluid communication with the buoyancy chamber. The buoyancy adjusting step comprises adjusting the quantity of air in the buoyancy chamber.

In some versions, the support structure includes a liquid inlet and a plurality of liquid outlets. A liquid passage connects the liquid inlet with the plurality of liquid outlets. The liquid outlets being located such that liquid provided through the liquid inlet is distributed through the plurality of outlets to the wastewater environment. The method further includes distributing nutrients or bacteria to the wastewater environment by providing a liquid containing such nutrients or bacteria through the liquid inlet.

A further version of a support structure has a first stage floatation structure and a second stage support structure to allow for additional buoyancy as the mass of the plants increase during growth.

### BRIEF DESCRIPTION OF THE DRAWINGS

FIG. 1 is a top view of a wastewater environment with a wastewater treatment system in accordance with an embodiment of the present invention located therein;

FIG. 2 is a cross-sectional side view of the wastewater environment and wastewater treatment system of FIG. 1;

FIG. 3 is a perspective view of a version of a support structure for use with the present invention;

FIG. 4 is a top view of an alternatively configured wastewater environment with an alternative embodiment of a wastewater treatment system in accordance with the present invention located therein;

FIG. 5 is a cross-sectional view of a portion of a support structure showing one approach to providing buoyancy chambers therein;

FIG. 6 is a cross-sectional view of an alternative approach to providing buoyancy chambers in a support structure;

FIG. 7 is a perspective view of an embodiment of a barrier structure for use with the present invention;

FIG. 8 is a perspective view of an alternative version of components of a barrier structure for use with the present invention;

FIG. 9 is a perspective view of a modular support structure for use with the present invention;

FIG. 10 is a perspective view of a modular support structure with the components arranged in a different manner;

FIG. 11 is an exploded view of a cross member and two plant holders forming part of a modular support structure;

FIG. 12 is a perspective view of an alternative version of a cross member and plant holder;

FIG. 13 is a perspective view of an alternative version of a cross member;

FIG. 14 is a perspective view of another version of a cross member;

FIG. 15 is a perspective view of yet another version of a cross member;

FIG. 16 is a perspective view of yet another version of a cross member;

FIG. 17 is a perspective view of a further embodiment of a support structure in accordance with the present invention:

FIG. 18 is a perspective view of a member that may form part of a support structure;

FIG. 19 is a detailed view of a portion of a curtain material that may be used for a hydraulic or biological curtain;

FIG. 20 is a perspective view of a further embodiment of a wastewater environment that forms an aspect of the present invention;

FIG. 21 is a perspective view of an embodiment of a hydraulic curtain assembly that may form a part of the present invention;

FIG. 22 is a perspective view of another embodiment of a wastewater environment that may form an aspect of the present invention;

FIG. 23 is a perspective view of an alternative support structure and curtain assembly without plants;

FIG. 24 is a perspective view of another version of the support structure and curtain assembly of FIG. 23;

FIG. 25 is a perspective view of a further version of the support structure and curtain assembly of FIG. 23; and

FIG. 26 is a perspective view of yet another version of the support structure and curtain assembly of FIG. 23.

### DETAILED DESCRIPTION OF THE PREFERRED EMBODIMENTS

The present invention provides several systems and methods for the treatment of wastewater using aquatic plants. To obtain the maximum benefits from aquatic plants in a wastewater treatment process, a judicious mix of emergent, floating and submerged species are used wherever possible. Emergent plants with an internal convective through-flow ventilation system have higher internal oxygen concentrations in the rhizomes and roots than other species (this oxygen is released into the aquatic environment in the treatment area) and are the species of choice for the treatment of wastewater by being positioned to establish a mat upon the surface of the wastewater. These species of plants are at their utmost metabolic performance in an aqueous environment with their root systems extending to a depth of about one 1.5 meters. Broad leafed floating macrophytes, with roots usually located between 50 cm. and three meters of depth, do not inject much oxygen into their environment but by being interspersed between emergent macrophyte populations can provide a good ventilation system to guarantee adjacent emergent plants are evenly exposed to the necessary wind gradients required for them to push the optimum amount of oxygen into their roots and rhizomes. Submerged-leaf macrophytes, which grow from the shallowest zones to about 9 meters, may be used for two purposes. First, since these plants do not interface with the air above the water, their leaves pick up substances in the body of water and may therefore be advantageously used as low-cost indicators to monitor the condition of the treated waters in terms of organic and inorganic substances at different depths. Secondly, these plants can grow in an anaerobic zone of a body of wastewater and provide anaerobic bacteria a support upon which they can attach and become more productive in the decomposition of sludge in this zone. Thus, by interspersing these three types of aquatic plants in a body of wastewater and staggering the depths at which these plants are grown, a homogeneously oxygen rich environment may be created for the bacteria to thrive.

Over two thousand years ago Archimedes discovered that objects in liquids are buoyed up by a force that is equal to the weight of the water they displace. Thus, there are three types of buoyancy. When an object displaces a greater weight of liquid than the object weighs, the object is said to be less dense than the liquid and have positive buoyancy, making it float. If an object displaces a lesser weight of liquid than the object weighs, the object is said to be denser than water and have negative buoyancy, which will make it sink. And if a body has a weight and density between the first two, it is said to have neutral buoyancy and it will stay at a given depth relative to the surface of the liquid. Embodiments of the present invention make use of neutral buoyancy in much the same way as submarines do. By accurately adjusting the density of a structure, the structure can remain at any level in a body of water without undue stress which may distort or damage it over time.

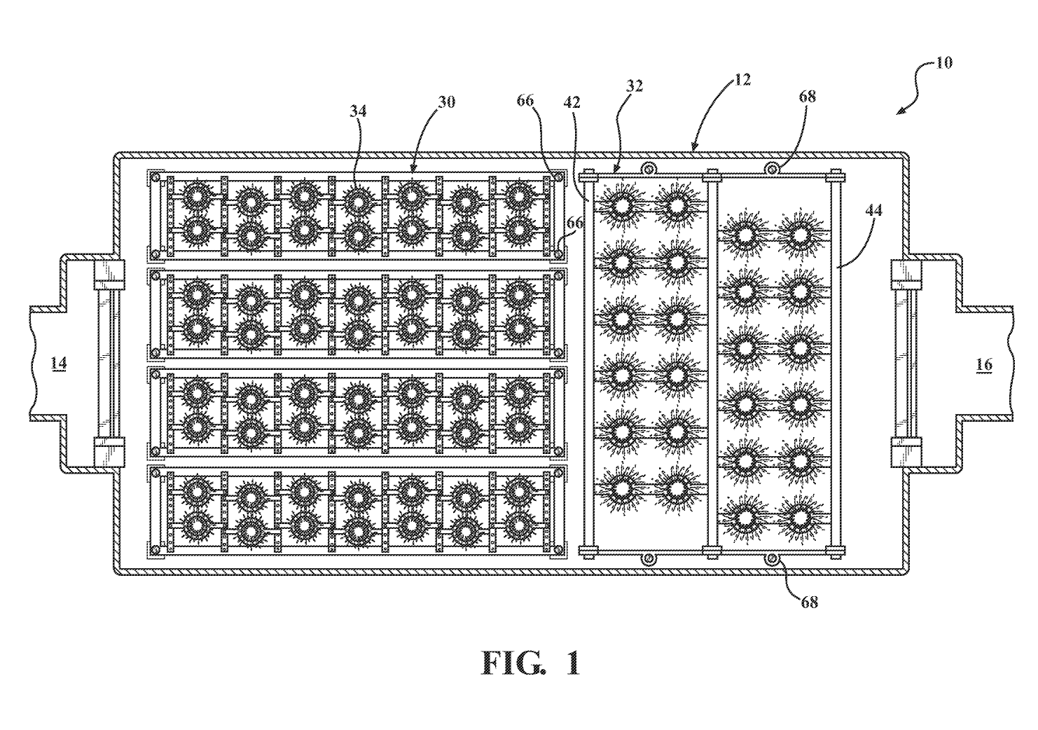

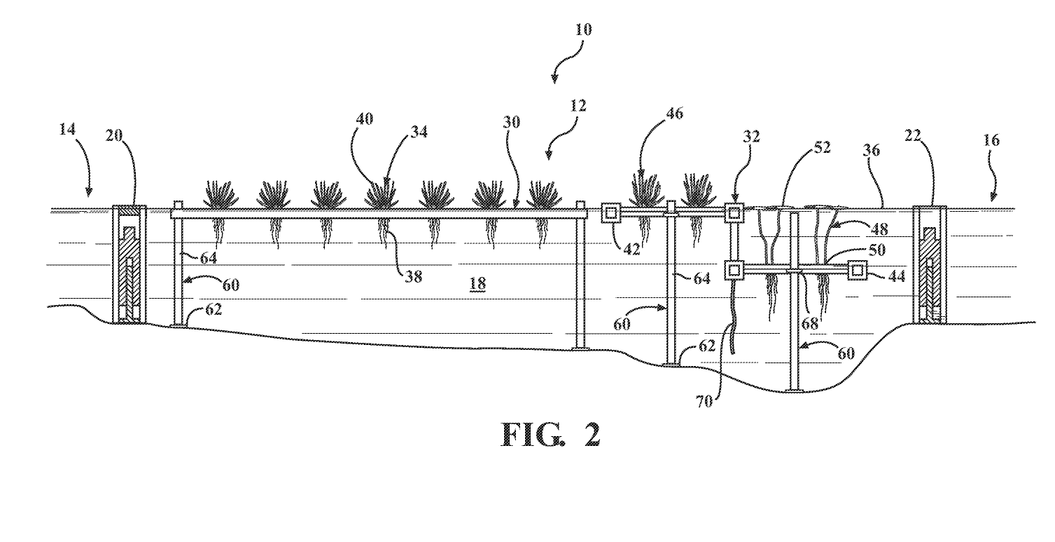

Referring to FIGS. 1 and 2, an exemplary wastewater environment is shown at 10, including a treatment zone 12, an inlet 14, and an outlet 16. The wastewater environment is filled with wastewater 18. Wastewater is allowed to flow from the inlet 14 into the treatment zone 12, where the wastewater 18 preferably remains for a desired treatment period sufficient to allow cleaning of the wastewater. After treatment, wastewater 18 is allowed to flow out through the outlet 16. From there, it may flow to an area for additional treatment or be returned to the environment.

In order to control the flow of wastewater from the inlet 14 into the treatment zone 12, systems in accordance with the present invention may include an inlet barrier structure 20 located adjacent the inlet 14. The inlet barrier structure may limit the flow of wastewater into the treatment zone and/or limit the backflow of wastewater from the treatment zone into the inlet. Systems in accordance with the present invention may also include an outlet barrier structure 22 located adjacent the outlet 16. The outlet barrier structure 22 may limit the flow of wastewater from the treatment zone 12 to the outlet 16 and/or limit the backflow of wastewater from the outlet to the treatment zone.

Some embodiments of the present invention may include both inlet and outlet barrier structures, while other embodiments include neither, and yet others include only an outlet barrier structure, or an inlet barrier structure, depending on the characteristics and design of the wastewater treatment system. Certain embodiments may have treatment zones arranged in series with a barrier structure therebetween. In this case, the barrier structure may serve as both an outlet barrier structure (from the first treatment zone) and an inlet barrier structure (to the next treatment zone).

A plurality of support structures is disposed in the wastewater 18 in the treatment zone 12. FIGS. 1 and 2 illustrate two styles of support structure. A first generally rectangular style support structure is shown at 30 and a second two-level support structure is shown at 32. These styles are exemplary, and additional styles may be provided. The support structure 30 is generally planar and supports a plurality of aquatic plants 34 all at approximately the same level, such that all of the plants 34 are disposed at approximately the same position relative to the upper surface 36 of the wastewater 18. The aquatic plants 34 represent a type of plant defined as emergent macrophytes. As shown, the macrophytes are positioned such that the roots 38 are submerged and the upper portion 40 of the plants 34 is above the upper surface of the water.

The illustrated second style support structure 32 has a first portion 42 disposed at a first level and a second portion 44 disposed at a second level with respect to the upper surface 36 of the wastewater 18. A first group of aquatic plants 46 is supported on the first portion 42 and a second group of aquatic plants 48 is supported on the second portion 44. In the illustration, the plants 46 are of the same type as the plants 34 and are positioned at a similar level or depth with respect to the upper surface 36. The plants 48 are floating leaf macrophytes and have a base 50 that is supported by the second portion 44 of the support structure 32 and leaves 52 that float on the upper surface 36.

The illustrated embodiment of the system also includes an anchoring system for maintaining the positions of the supports structures 30 and 32 within the treatment zone, so that they do not float around. The anchoring system includes a plurality of anchoring elements 60. These anchoring elements may take a variety of forms, but preferably allow the support structures to move upwardly and downwardly as the quantity of wastewater in the treatment zone changes while preventing the structures from moving too much side-to-side or front-to-back in the treatment zone 12. The illustrated anchoring elements include a foot 62 disposed on the bottom of the treatment zone and a post 64 extending upwardly therefrom. The posts 64 are received in guides on the support structures such that the guides slide upwardly and downwardly on the posts as the level of wastewater changes. In FIG. 1, the guides for the support structures 30 are openings in the support structures with the posts extending through the openings. The guides for the support structure 32 take the form of rings 68 attached to the outside of the support structure, with the posts extending through the rings. As will be clear to those of skill in the art, the guides and anchoring elements may take a variety of other forms.

In accordance with the present invention, each of the support structures preferably has adjustable buoyancy. This allows the buoyancy of the structure, with its associated aquatic plants, to be adjusted to obtain the desired buoyancy. In preferred versions, the buoyancy is adjusted to make the structures, with plants, neutrally buoyant in the particular wastewater environment at a chosen position relative to the upper surface. As known to those of skill in the art, the density of the wastewater may vary, depending on its characteristics. It is preferred that the buoyancy of the structures be adjusted to reach a neutral buoyancy and to establish a desired position or depth of a particular support structure to place the plants at a desired position and to obtain the desired performance of the wastewater treatment system.

Most wastewater treatment facilities are dimensioned on the basis of a given amount of influent wastewater with a given amount of organic and inorganic content to be treated in a given amount of time to obtain an effluent of the desired quality. However, after an intense rainstorm, or unanticipated changes in quality of the wastewater (for example, caused by unanticipated discharges of concentrated wastes from local factories), the wastewater parameters used to dimension a facility may change drastically. To address these changes the present invention provides rising barrier structures, including the inlet barrier structure 20 and the outlet barrier structure 22. Under normal circumstances, these barrier structures are designed to let water pass over the top of the barrier, with the upper portion of each barrier structure in a lowered position. However, under circumstances caused by an intense rainstorm or a change in the amount, or quality, of the waste in the wastewater, the inlet and/or outlet barrier structures may be manually or electronically raised to a raised position, to retain water in the treatment zone and expose it to a longer period of bacterial action in a highly oxygenated environment. The present invention may also provide sediment removing structures that may also incrementally raise barriers to the effluent discharge increasing the amount of wastewater in the treatment area and simultaneously pump sediments out of the treatment area to be processed elsewhere providing more oxygen to the bacteria in the aerobic strata of the wastewater. Depending upon the embankment contours of the body of wastewater this increased holding time may easily be as much as 200% of that for which the project is dimensioned under normal operating conditions.

Some embodiments of the present invention may include a water barrier or skirt for directing the flow of wastewater relative to the support structures and plants. An exemplary skirt is shown at 70 in FIG. 2, attached to the support structure 32 and extending downwardly toward the bottom of the treatment zone. The skirt 32 is a generally planar piece of material that either resists or blocks the flow of wastewater. As such, wastewater is encouraged to flow upwardly to the plants 46 and 48. A skirt may be attached to a support structure, as shown, to portions of the anchoring system, or supported in other ways.

In other embodiments of the present invention, support structures may be provided in a different arrangement or different support structures may be used. As one example, generally planar support structures 30 may be disposed in a wastewater environment and the buoyancy adjusted such that the support structures are at different depths. Some may be immersed adjacent the upper surface as in FIG. 1 while others are submerged at different depths. Different types of aquatic plants may be provided on different support structures or mixed on some support structures. Aquatic plants may include emergent macrophytes for use adjacent the surface, floating leaf macrophytes with bases that are submerged and leaves that float, and submerged leaf macrophytes with leaves and bases that are submerged. As will be clear to those of skill in the art, these different types of plants may work best in the treatment of wastewater if they are located at different depths. The position of the support structures, and therefore the plants, may be adjusted to adjust the performance of the system. Support structures may be located at a single depth, two different depths, three different depths, or more.

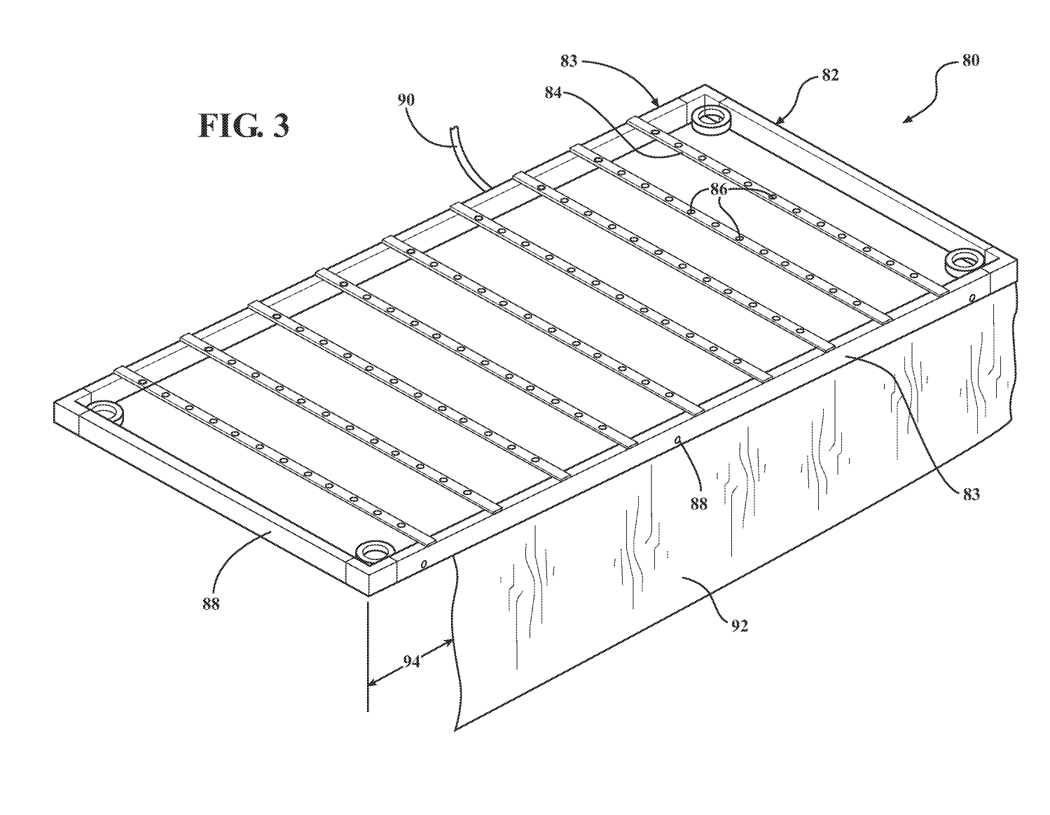

FIG. 3 illustrates an exemplary support structure 80 for use with the present invention. The support structure 80 includes a support frame 82 that, in this version, is rectangular and formed of four frame members 83. The frame members are preferably hollow tubular members, such as the rectangular tubing shown. Cross members 84 extend between the frame members 83. These cross members may serve as plant holders with a plurality of plant receiving areas 86. Alternatively, the cross members may support plant holders. For example, in FIG. 1, the support structure 30 is generally rectangular and has cross members that extend between opposed sides of the structure 30. Plant holders with plant receiving areas extend between the cross members.

Referring again to FIG. 3, the frame members 83 are shown with openings or holes 88 near their lower edge, distributed around the perimeter of the support frame 82. In this embodiment, the holes 88 communicate with the hollow interior of the support frame 82. If air is provided through the holes 88, the air will fill the upper part of the frame members 83, thereby increasing the buoyancy of the support structure. Alternatively, if air is removed, buoyancy is decreased. Also, if liquid is introduced through any of the holes 88, this liquid will flow through the frame members, which act as a liquid passage, and out of the other holes 88, serving as liquid outlets. As such, a liquid may be introduced into a liquid inlet hole for distribution to the wastewater surrounding the support structure. A hose 90 is shown connected to a liquid inlet on the back of the support structure 80. The hose 90 may be used to introduce air or liquid. Ballast may be attached to the support structure or disposed therein, such as metal plates or gravel inside the frame members 83, to balance the structure and help achieve a desired buoyancy level.

A skirt 92 is shown having an upper edge attached to the support structure 80 and a body that extends downwardly. In the illustrated version, the skirt extends from one end of the support structure part way to the other end, but leaves a gap 94 near one end. Alternatively, the skirt may have other sizes or configurations, such as extending the entire length. In one approach, support structures 80 are disposed such that their long dimension is generally perpendicular to the direction of wastewater flow in a treatment zone. By placing full-length skirts on the edge of each support structure, wastewater will be forced to interact with the plants. Further versions of skirts may have openings therein, such as openings adjacent the bottom of the support structure 80 so that wastewater flows up and passes just beneath the support structure. The support structures may be disposed at various depths.

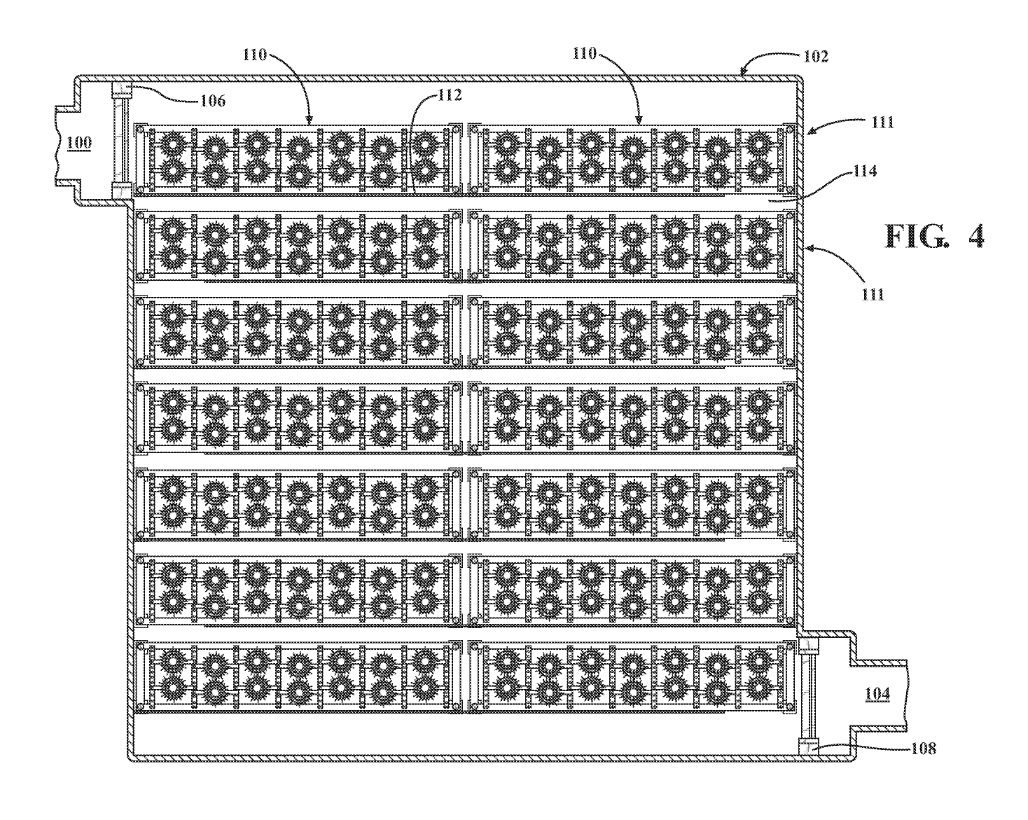

Referring now to FIG. 4, at alternative arrangement for a wastewater treatment system is illustrated. A wastewater environment has an inlet 100, a treatment zone 102 and an outlet 104. An inlet barrier structure 106 is disposed between the inlet 100 and treatment zone 102 and an outlet barrier structure 108 is disposed between the treatment zone 102 and outlet 104. A plurality of support structures 110 are disposed in the treatment zone 102, generally in a grid. Each support structure has a length and a width with the length being greater than the width. Two support structures are positioned end to end to provide an elongated row 111. In the illustrated embodiment, seven side by side rows 111 are provided. Skirts 112 are disposed between the rows 111 and may be attached to the support structures or supported in other ways. The skirts have a gap 114 near the end of each row, with the position of the gap alternating with each row. As such, the skirts define a flow path that zigzags back and forth, following the length of the rows and maximizing exposure of the wastewater to the plants. The system is illustrated as having a single type of plant, but multiple types may be used, and support structures may be provided at various depths.

As discussed above, support structures for use with the present invention preferably have adjustable buoyancy. FIG. 5 illustrates one approach to providing adjustable buoyancy. A frame member 120 of a support structure is shown in cross section. Two buoyancy chambers are shown disposed inside the frame member 120. Alternatively, they may be exterior to the frame member, shaped in other ways, or located differently. The area surrounding the chambers inside the frame member 120 may be filled with wastewater. The use of two buoyancy chambers in opposite ends of the frame member allows the buoyancy to be balanced end to end, since the weight of the plants on the support structure may be inconsistent, a skirt may be attached to one side, etc. A plurality of buoyancy chambers maybe provided, distributed in the support structure, to allow balancing. Alternatively, a single buoyancy chamber may be provided. In one example, the entire frame of the support structure acts as a buoyancy chamber.

In FIG. 5, the buoyancy chamber 124 is shown as having an opening 126 in its lower surface. Air may be added through this opening in order to increase buoyancy. In one approach, supply tube 128 extends through opening 126 and terminates adjacent the upper part of the chamber 122. Air may then be added or extracted through the tube 128 to adjust the buoyancy. As air is added or removed, wastewater flows in or out of the opening 126. In another approach, air is added through tube 128, which may terminate near the bottom of the chamber, but is removed through optional air valve, such as at 130. An air valve such as 130 may also be used to add air. An air tube may be attached to valve 130. A plurality of tubes may be provided to a plurality of buoyancy chambers to allow adjustment and tuning of buoyancy, even from a remote location. Depending on the natural (without added air) buoyancy of the support structure, ballast may be needed to avoid positive or excess buoyancy. Ballast plates 132 are shown in the chamber 122. They may alternatively be located outside the chamber, in or on the frame member or elsewhere. Ballast may be metal plates or other ballast material, such as gravel.

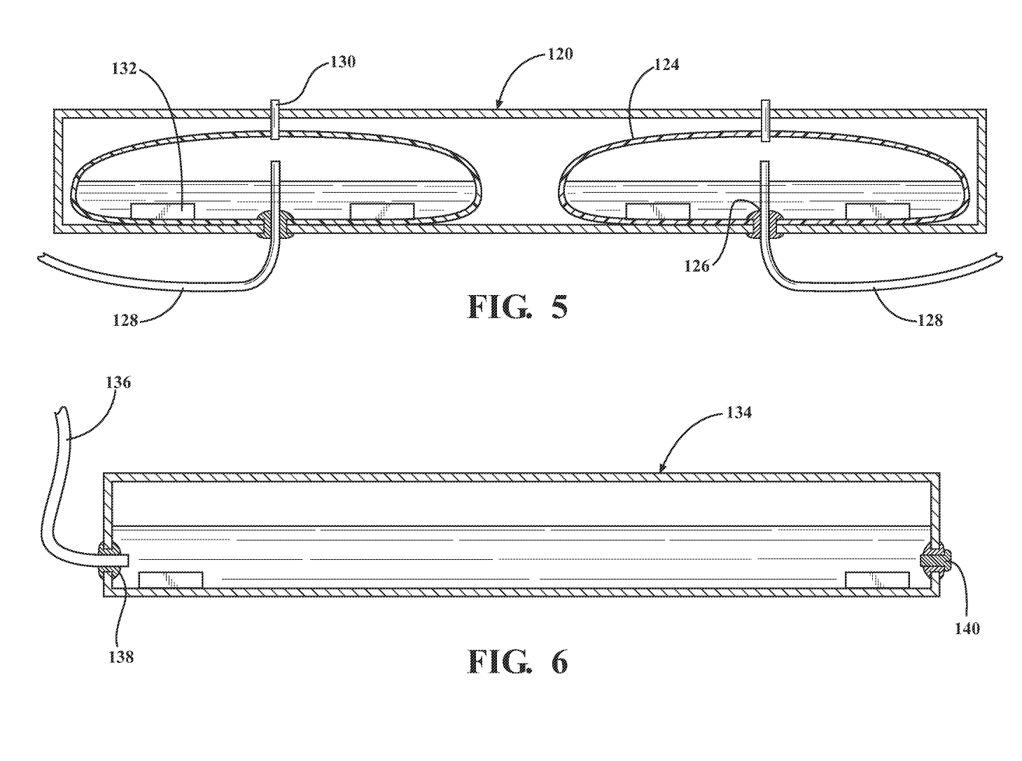

FIG. 6 illustrates an alternative approach to adjusting buoyancy in which a frame member 134 is filled partially with air and partially with water. A supply tube 136 communicates with an inlet 138. Air may be provided, which will displace water out an outlet 140. If liquid is provided through the inlet 138, this liquid will flow to the outlet 140. As discussed with respect to FIG. 3, this may be used to distribute nutrients or microbes to the wastewater surrounding the support structure. While the frame member 130 is shown as having a single chamber therein, it may alternatively have dividers to divide it into separate buoyancy chambers.

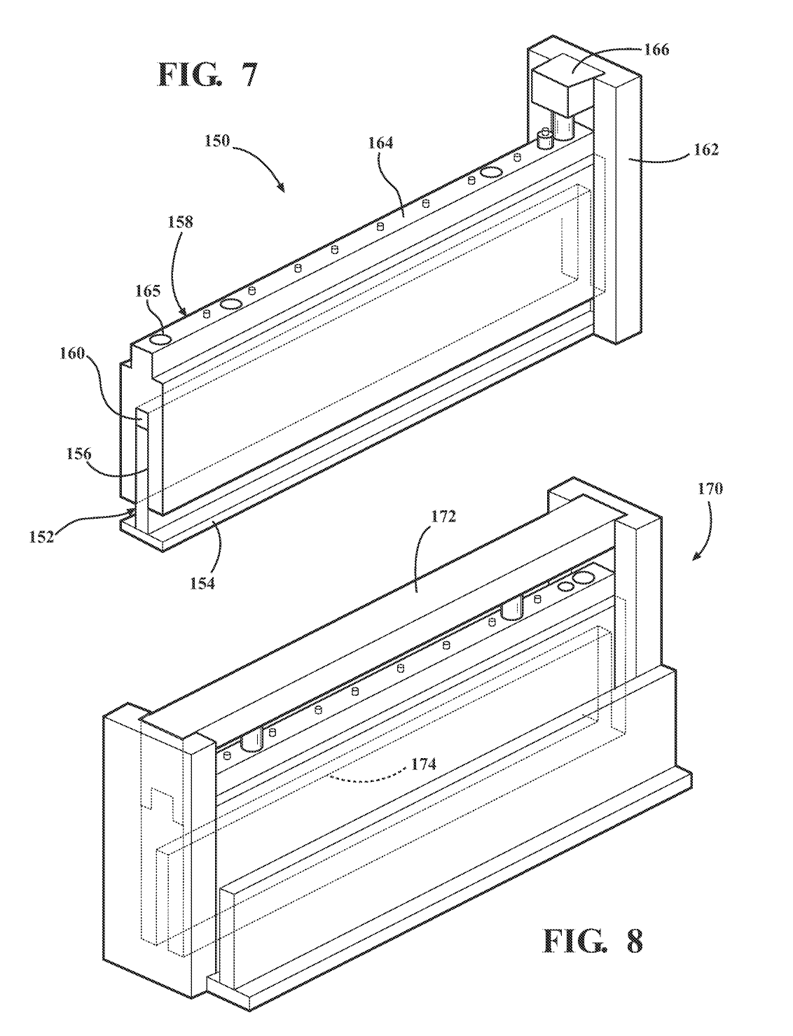

As discussed with respect to FIG. 1, systems in accordance with the present invention may include inlet and/or outlet barrier structures. These may take a variety of forms. FIG. 7 illustrates an exemplary barrier structure 150. The structure includes a base 152 with a lower portion 154 to be disposed on the bottom of the treatment zone adjacent the inlet or outlet. The base 152 includes a guide portion 156 that extends upwardly from the base 154. An upper portion 158 of the structure 150 movably engages the guide portion 156. A slot 160 in the underside of the upper portion 158 receives the guide portion. Pressure release holes 165 allow water to pass in and out of the slot 160 as the upper portion moves upwardly and downwardly. The base 154 and upper portion 158 cooperate to define a barrier limiting the passage of water. A lateral support 162 is disposed adjacent each end of the upper portion 158 for stabilizing and guiding the upper portion. In some embodiments, the upper portion has an adjustable buoyancy. The buoyancy may be adjusted such that the upper portion is neutrally buoyant with its upper edge 164 near or at the upper surface of the water. As such, the upper portion will move upwardly and downwardly with the level of wastewater. Its buoyancy may be tuned to allow a desired amount of water to flow past, and it will then self-regulate as the water level changes. The buoyancy adjustment may be accomplished in a variety of ways, including as illustrated in FIGS. 5 and 6. In one example, the upper portion is at least partially hollow and air is added or removed to adjust buoyancy. In another, a buoyancy chamber is provided either in or attached to the upper portion 158.

A motor 166 may be provided for raising or lowering the upper portion to increase or decrease the flow of water past the barrier. The motor may override the level of the upper portion due to buoyancy. The motor may be implemented in a number of ways.

Referring now to FIG. 8, an alternative barrier structure is shown at 170 with the base illustrated separately. This structure differs from the version in FIG. 7 in that a skimmer element 172 is interconnected with the upper portion 174 and spaced therefrom so as to define a slot therebetween. In use, the buoyancy of the upper portion 174 may be adjusted such that the skimmer element is at the surface. This blocks floating debris but allows water under the surface to flow through the slot under the skimmer element. In some versions of a wastewater treatment system in accordance with the present invention, a barrier structure with a skimmer is used at the inlet to prevent floating debris from entering the treatment zone. Though not shown, the barrier 170 may also include a motor for adjusting the position of the upper portion, and the motor may be implemented in a number of ways.

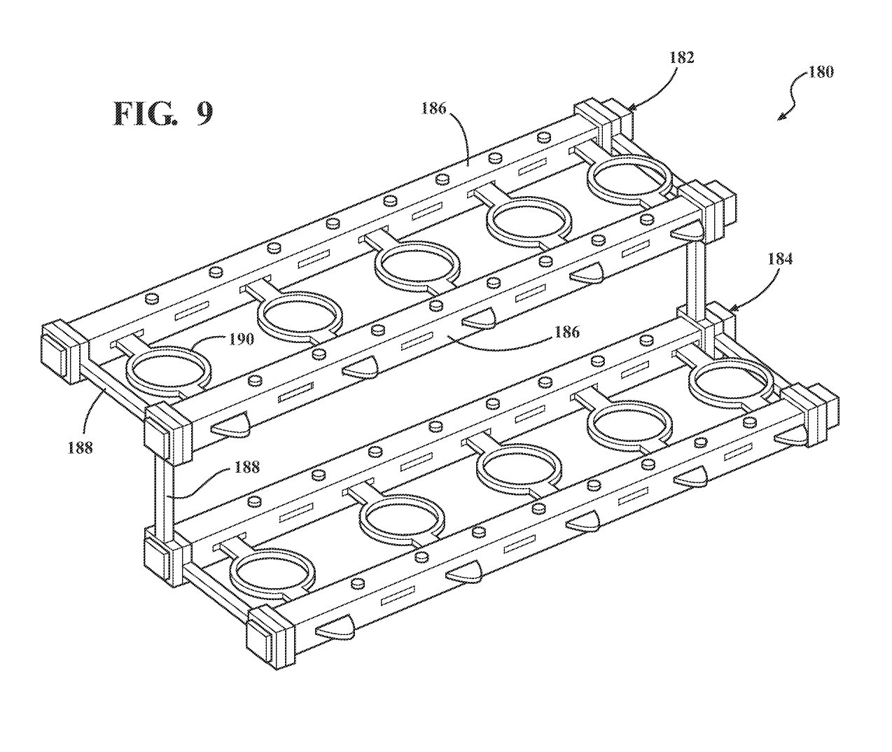

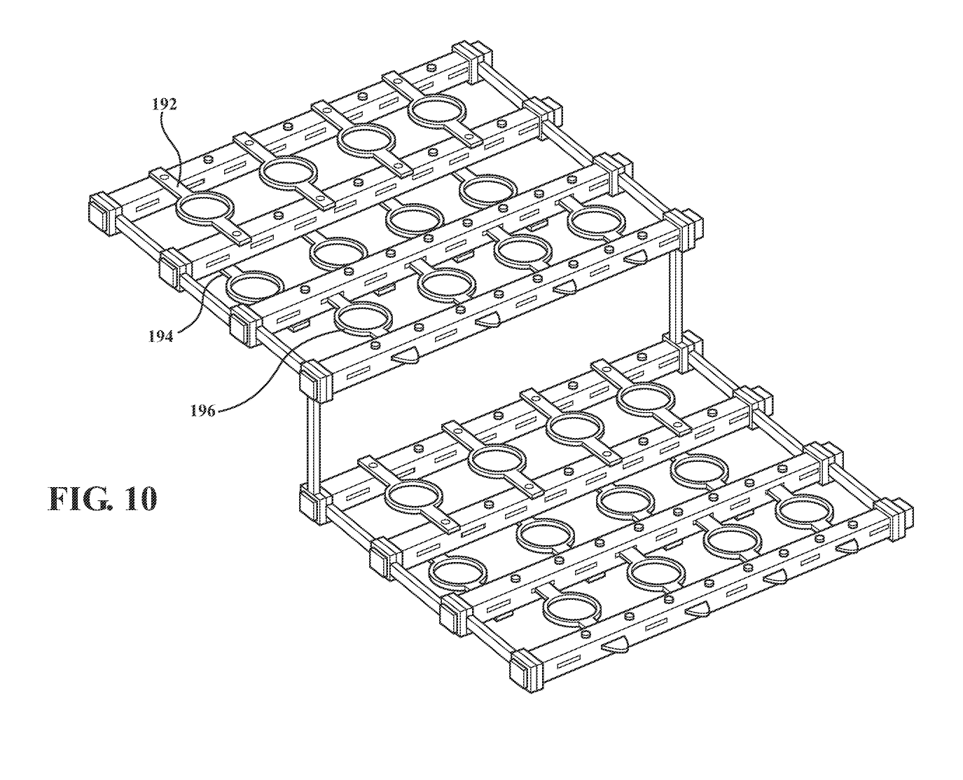

FIG. 9 shows an alternative two-level support structure 180 having a first level 182 and a second level 184. The support structure 180 is constructed from elongated support elements 186 interconnected by cross members or links 188 and plant supports 190. As shown, the support elements 186 have a plurality of connection points or connection features engaged by the links and plant supports. The members and links may be arranged in various ways to provide various configurations. FIG. 10 shows an alternative version with a larger first and second level. Also, some plant supports 192 are interconnected with the upper sides of the support elements, other plant supports 194 are interconnected with the lower sides, and yet other plant supports 196 engaged the middle of the support elements. This allows plants to be at slightly different levels on the same level of the support structure.

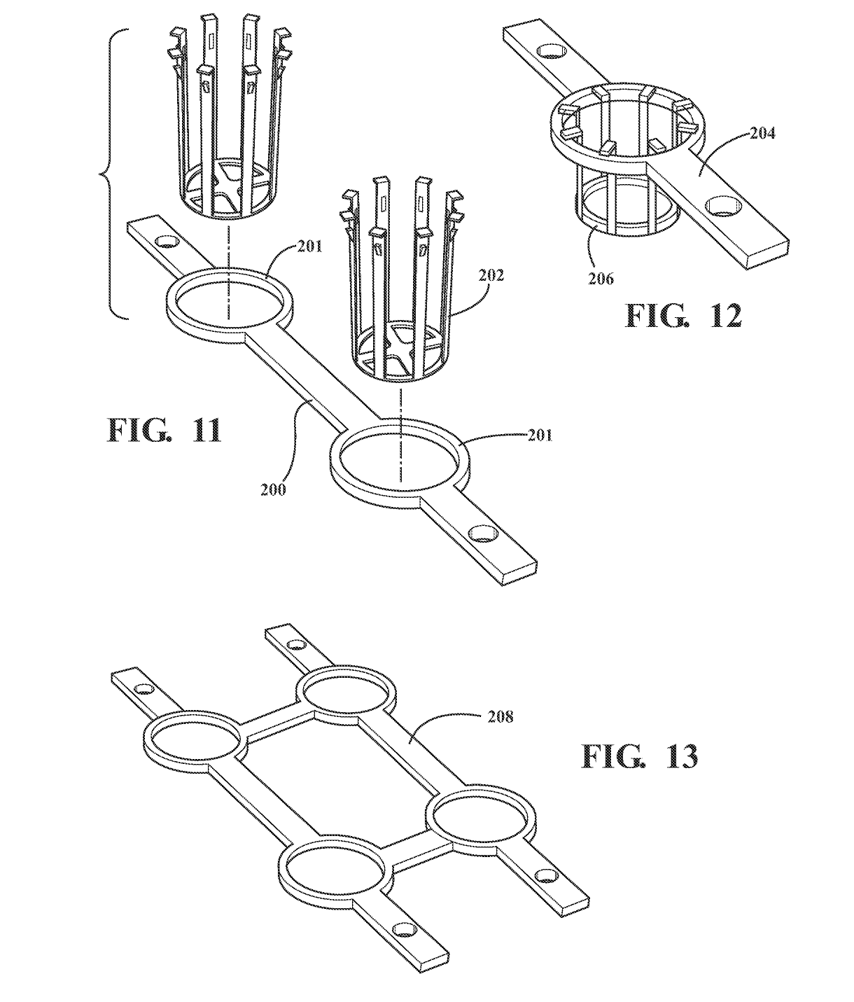

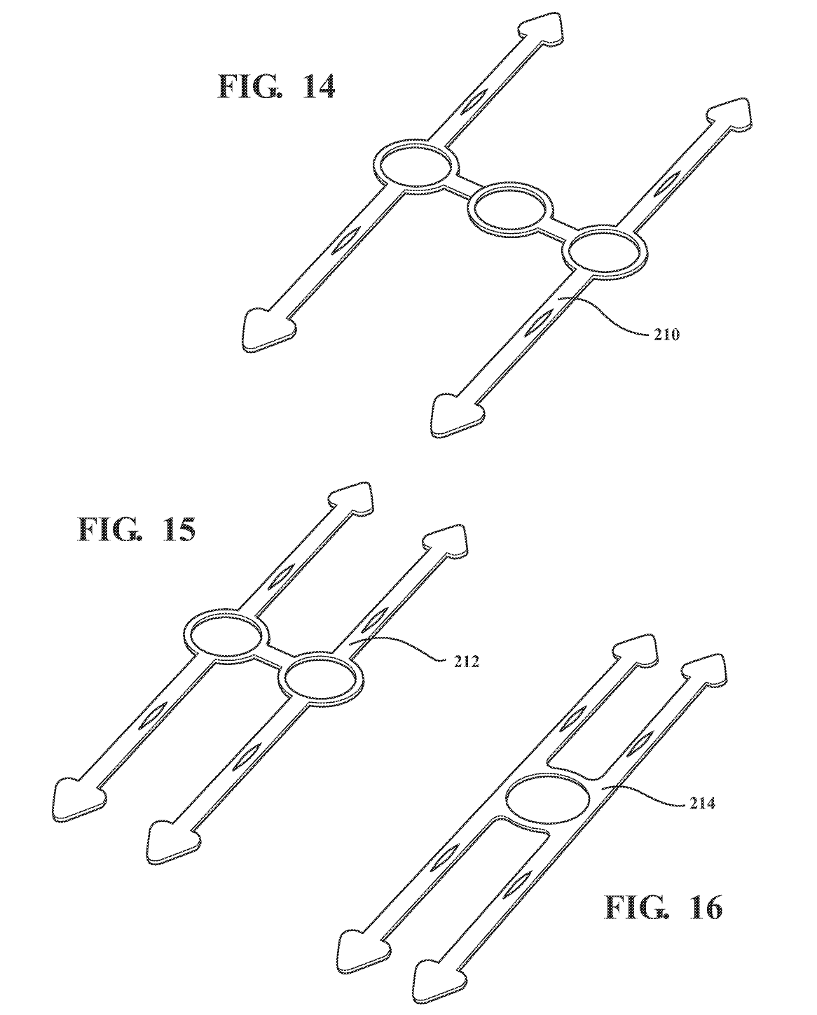

FIG. 11 shows a plant support 200 for use with support structures. It has two plant receiving areas 201 and plant holders 202 that engage the receiving areas. As shown, the holders extend downwardly to allow the base of a plant to be positioned below the plant holder. FIG. 12 illustrates an alternative shorter plant support 204 with a shorter holder 206. FIGS. 13-16 show further alternative plant supports 208-214. The various plant supports and support structures may be combined to provide a plurality of configurations.

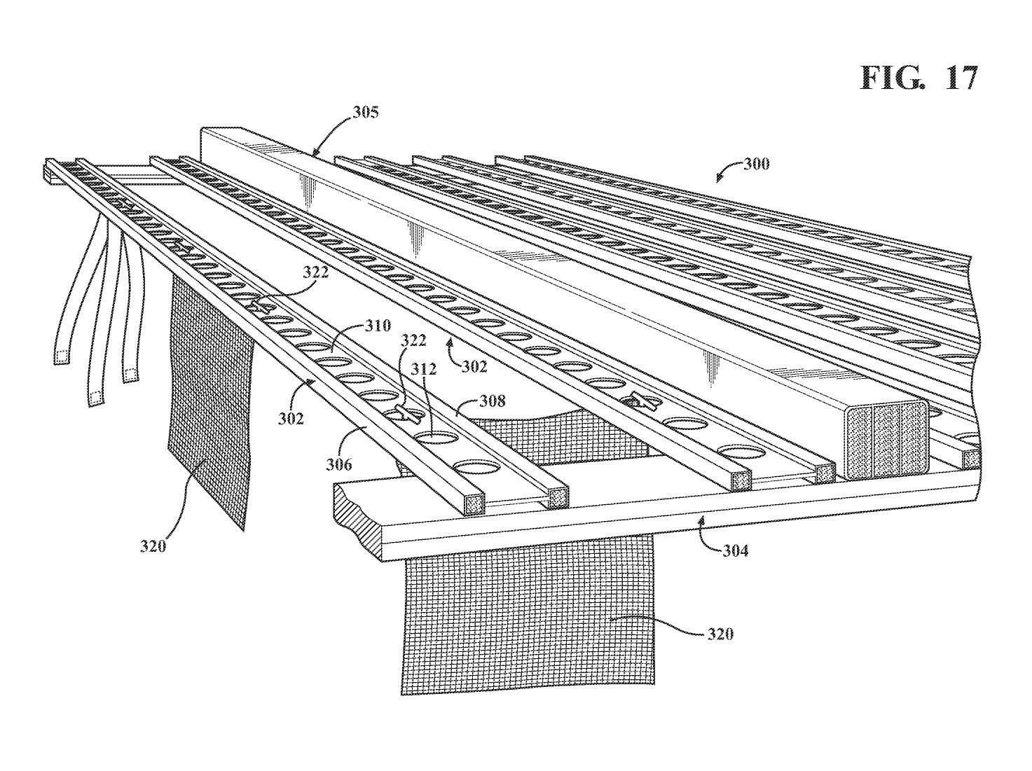

Referring now to FIG. 17, a further embodiment of a support structure 300 is shown. This support structure provides two or three stages of flotation, depending on the configuration, as will be described below. The structure 300 includes a plurality of elongated cross members 302, which in this embodiment are arranged parallel to one another. The opposed ends of the cross members 302 rest on a pair of primary floatation devices 304, which may be considered first stage members. These floatation devices may be elongated hollow members, formed of buoyant material, or formed in other ways. The illustrated versions have lines along the sides and ends, which may represent a stack of buoyant sheets, or may be lines on the outside of a hollow member.

In this embodiment, the cross members each comprise a parallel pair of elongated floatation members 306 and 308 that are interconnected by a web 310 extending therebetween. The web has openings 312 defined therethrough at periodic intervals. The openings may receive plants or plant holders, such as the plant holders shown at 202 or 206 in FIGS. 11 and 12. These plant holders are inserted into the openings 312 and a plant is supported therein.

In the illustrated embodiment, the floatation members 306 and 308 are each hollow square tubes and the web 310 is a planar element giving the members an I-beam-like appearance. The members 306 and 308 are shown with filled ends so as to define a floatation chamber therein. The cross members, with floatation chambers, may be considered a second stage floatation member.

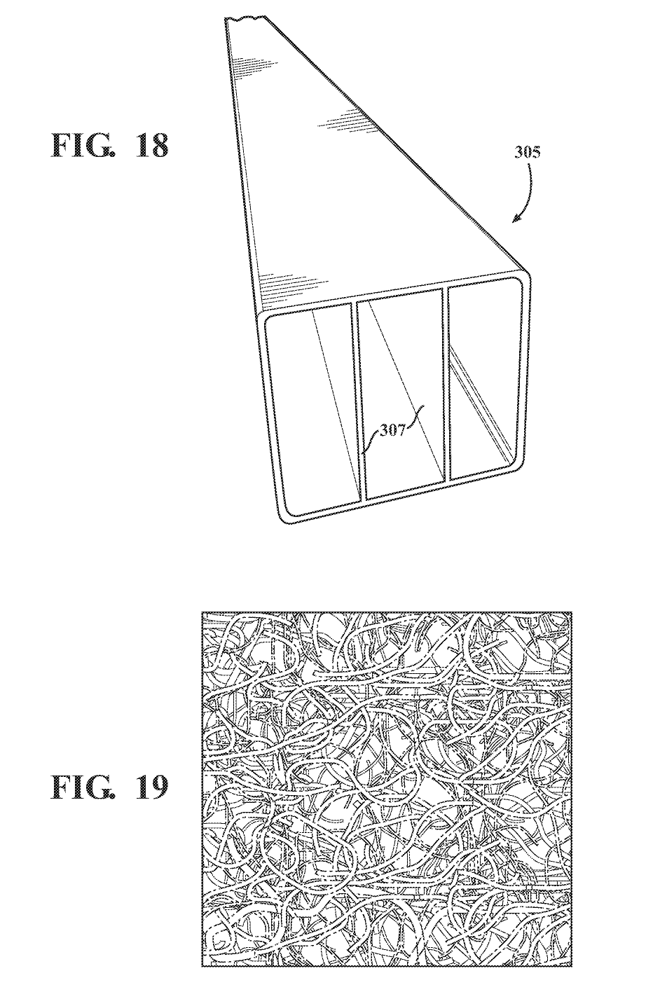

The support structure 300 may include one or more optional third stage floatation members, such as member 305, disposed on top of the first stage members 304. This member may take several forms. In FIG. 17, the member 308 is an elongated square member with internal partitions and filled ends to define internal floatation chambers. FIG. 18 shows member 305 without the sealed ends. Internal partitions 307 extend along the length of the member 305 so as to divide it into 3 chambers. This allows flexibility in use, since one, two or three of the internal chambers may be sealed so as to be floatation chambers, depending on the buoyancy desired. Alternatively, all chambers may be sealed and later the sidewall of one or more chamber may be perforated to changed the buoyancy of the member. One or more chambers may also be filled with ballast, if needed. Member 305 may be used in place of members 304 in some embodiments, such that the first and third stage floatation members are the same. In the illustrated embodiment, the first stage members are spaced apart and generally parallel to each other, and the cross members 302 are also spaced apart and generally parallel to each other. The cross members are generally perpendicular to the first stage members and extend between and interconnect the first stage members. The third stage members 305 are generally perpendicular to the first stage members 304 and generally parallel to the cross members 302. The cross members may be equally spaced with the third stage members disposed in one of the gaps between the cross members.

When embodiments of the present invention are used to support plants in a wastewater environment, the plants may start as seedlings or small plants and then grow over time and increase in weight. The embodiment of FIG. 17 is designed to support the small plants at an appropriate height by the buoyancy of the first stage floatation devices 304. Because the plants are light at this stage, the floatation devices cause the cross members 302 to be supported above the upper surface of the water. The plants are supported in downwardly extending plant holders. The sizes of the components are chosen such that the small plants are at an appropriate level, which may be with only their roots immersed. As the plants gain weight, the support structure 300 experiences a higher load and the first stage floatation devices 304 are pushed lower in the water until the cross members reach the surface. At this point, the floatation members 306 and 308 of the cross members act as a second stage floatation structure, adding buoyancy to the structure 300. This avoids the transplanting that is necessary with static structures. In some versions, the first stage floatation devices 304 are sized so as to displace a volume of water with a weight equal to their own structure, the second stage floatation structure, any attached plant holders, and the young plants in the attached holders. They may also support the third stage members 305. The second stage floatation structure, formed by the members 306 and 308, are sized so as to displace a volume of water with a weight equal to that of the increased weight that is gained by the plants as they grow. The third stage floatation member or members 305 provide additional buoyancy as the plants gain weight, or may provide a margin of additional buoyancy.

As will be clear to those of skill in the art, the sizes, shapes, relative volumes and positions of the components of the structure 300 may be adjusted so as to achieve the desired performance. For example, the members 306 and 308 may be larger in some versions. The embodiment of FIG. 17 may be combined with any prior embodiment and with any features thereof. For example, the floatation chambers in the structure 300 may have adjustable buoyance, achieved in a number of ways, and may be used with skirts and guide posts, as previously discussed. Further versions of the support structure may have additional floatation structures, such as the third stage that contacts the water at the same time or after the second stage. Alternatively, some support structures may have neutral buoyancy and/or be submerged at various depths, as was discussed for previous embodiments. Different levels of buoyancy may be achieved by perforating some of the buoyancy chambers of various stages of the support structure.

FIG. 17 also illustrates skirts 320 that may be used with any of the embodiments of the present invention. The skirts 320 may be in addition to or instead of the skirts previously discussed. The skirts 320 may be formed of a fiberglass cloth or mesh, carbon mesh, polypropylene mesh, or any material that promotes the creation of a biofilm thereon. FIG. 19 provides a detailed view of a portion of a non-woven mesh material used in some embodiments. In some versions, this is a polypropylene mesh. Bacteria generally do not have a means of mobility to stay in place if there is a current in the wastewater. Some bacteria may attach to the roots of the plants in the wastewater. The skirts 320 provide additional areas for bacteria to attach, creating a biofilm. A plurality of such skirts 320 may be attached to platforms in a variety of ways to provide biofilm area, sheltered areas, and to direct current flow. One approach to attaching the skirts 320 is a T-shaped hook 322 that engages the plant openings. Other approaches may also be used. The skirts may have weights or weighted areas thereon to assist in positioning the skirts. FIG. 17 also illustrates bio-strips 324 for use with any of the embodiments of the present invention

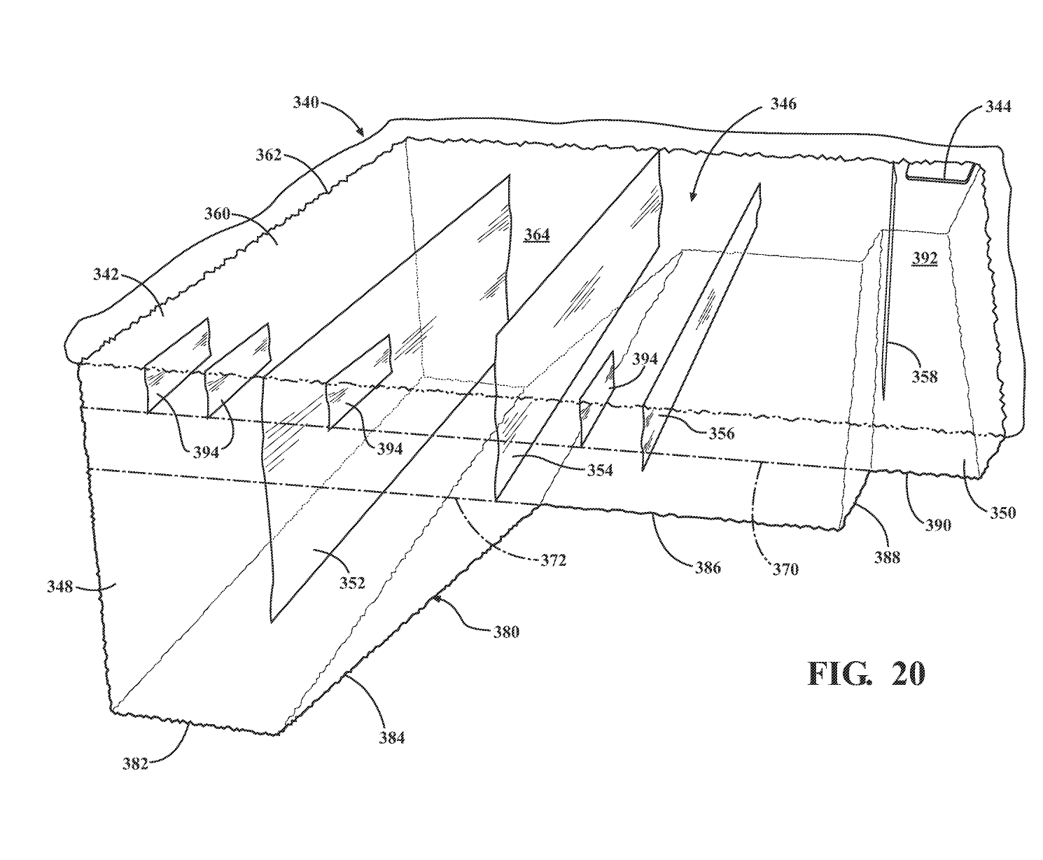

Referring now to FIG. 20, an additional aspect of the present invention will be described. FIG. 20 provides a perspective view of a wastewater environment 340 having an inlet 342, an outlet 344, and a treatment zone 346 extending therebetween. The inlet and outlet may both have interconnecting channels. In some embodiments of the present invention, the wastewater environment is constructed so as to have zones with different depths. As shown in FIG. 18, the wastewater environment 346 has a deeper area 348 adjacent the inlet 342 and a shallower area 350 adjacent the outlet 344. In the illustrated embodiment, the wastewater treatment zone 346 is generally rectangular with the inlet being at one corner and the outlet being at an opposite corner, but other configurations may be used. Channels or lanes are defined between the inlet 342 and outlet 344 by hydraulic curtains 352, 354, 356, and 358. As shown, the curtains are staggered so as to define a channel or lanes that zigzag back and forth across the treatment zone 346. That is, the first lane 360 is defined between one end wall 362 of the environment 340 and a hydraulic 352 spaced therefrom. In the illustrated embodiment, the wall 362 and curtain 352 are generally parallel to each other so as to define a lane extending from the inlet 342 to the far side of the zone 346. The curtain 352 stops short of the wall opposite the inlet so as to allow water to flow around the curtain into an adjacent lane 364. This pattern continues so as to provide a plurality of interconnected side-by-side lanes to define a zigzagging path between the inlet and outlet. This allows a lengthy transit for wastewater in a small footprint for the wastewater environment 340.

As known to those of skill in the art, a relatively deep body of wastewater may be defined as having three general strata or regions. In the installation of the present invention, the uppermost region is a highly oxygenated layer of water near the upper surface. In FIG. 20, this is indicated as the area above line 370. Below the highly oxygenated aerobic area is a facultative zone, defined between lines 370 and 372. This zone or stratum is less oxygenated than the aerobic stratum. Below the facultative stratum, below line 372, is a layer with little or no oxygen, known as an anaerobic zone. It should be noted that there is no clear or concrete demarcation between these various strata, and the transition between strata may occur at different depths. The relative thickness of the various layers may be different than illustrated. The thickness of each stratum depends on the characteristics of the wastewater environment and how oxygen is distributed in the water. The type of wastewater treatment that occurs in the different layers relies on different processes and different bacteria. In one example of a body of wastewater, the aerobic zone may have a depth of approximately 1 meter or less, the facultative zone may extend from about 1 meter deep to 2 meters deep, and the anaerobic zone may extend from about 2 meters in depth to 6 or more meters deep. In some versions, the deep zone may be less deep, such as approximately 3.5 meters or more. FIG. 20 represents a wastewater environment with this general depth arrangement, but other layer thicknesses may occur in other environments, or the environment may be manipulated to obtain a desired oxygen distribution. Further, the environment may be tested for oxygen distribution and adjustments made to best treat wastewater in the tested environment by means of bioaugmentation or regulation of the influent and effluent wastewaters.

In the illustrated embodiment, the treatment zone 346 is shaped such that the deepest area, at 348, includes the first lane 360. As such, wastewater flowing into the inlet 342 may seek any of the levels of the environment. A particle of waste is typically heavier than pure water, but contains water. This particle therefore sinks to the anaerobic layer where anaerobic bacteria can decompose the waste through a variety of complex chemical processes, releasing clean or cleaner water. This cleaner water then rises to the upper aerobic layer where it can mix with other waste and sink to a lower layer again. The upper layer's water will typically be cleaner than the lower layer's water and as the wastewater flows from the first lane 360 to the second lane 364, the depth of the water decreases. Specifically, the bottom or floor 380 of the treatment zone 346 has a deep section 382 and then a sloped area 384 leading to an intermediate area 386. Preferably, the sloped area 384 slopes upwardly at a steep enough angle, or steps upwardly sufficient, so that sludge or deposits from the initial treatment remain in the deep area 382. Preferably, the transition from one area to another is an upwardly sloped transition, with the slope being in the range of 33 to 90 degrees, inclusive. An angle of 45 or more degrees is more preferred, but other angles and shapes may be used. The lanes get consecutively shallower and preferably include at least one lane that is in the intermediate area 386. The bottom then slopes upwardly again at 388 to a shallowest area 390. Again, this upward slope 388 is steep enough to return sediment to the area 386, preferably 45 degrees or greater. The lane 392 closest to the outlet 344 is disposed above the shallow area 390. In versions of the present invention having multiple depths, there may be 2, 3, 4 or more different depths, and the areas may be connected by slopes greater than 45 degrees, or not. As shown, these areas of different depths are continuous with each other.

As shown, the hydraulic curtains 352, 354, 356, and 358 preferably extend at least partway from the upper surface of the treatment zone 346 to the bottom 380. In some versions they reach the bottom and in some they stop short of the bottom. They may be weighted or otherwise constrained to assist in channeling the flow of wastewater. These hydraulic curtains or skirts may be formed of a material that generally blocks or slows the flow of water so as to constrain the flow of water mostly to the lanes. Bacteria may grow on the hydraulic curtains. The system may also include biological skirts or curtains in each lane, such as indicated at 394. These additional biological curtains may be parallel to the hydraulic curtains, perpendicular thereto, or at other positions or angles. These biological curtains preferably provide a surface on which bacteria may grow for treatment of water in one or more of the zones. In the illustrated embodiment, the biological skirts 394 extend only partway through the aerobic layer of the wastewater environment, though they may extend further and be arranged differently than shown.

While not shown, the embodiment of FIG. 20, the system preferably also includes support structures for supporting aquatic plants, in accordance with the various embodiments previously discussed. Preferably, such structures are in all or some of the lanes and the support structures may also support some or all of the skirts.

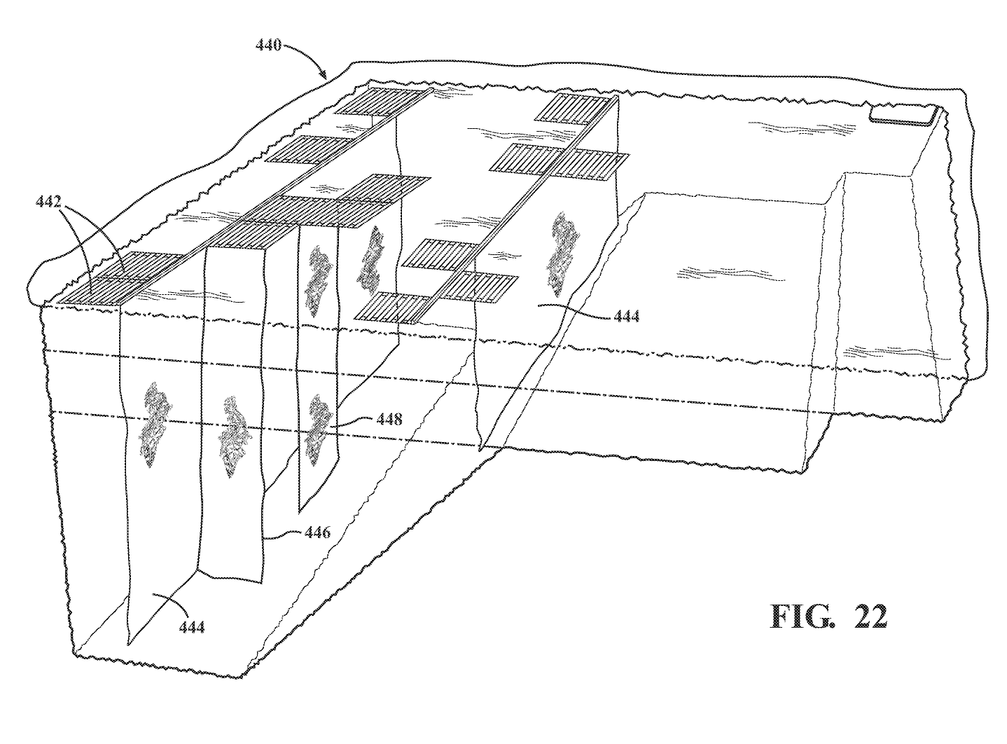

The embodiment of FIG. 20 is small, and some preferred embodiments are substantially larger. In some versions, the support structure shown in FIG. 17 measures approximately 2 meters by 2 meters, and supports 50 or more plants per square meter to provide high plant density. A wastewater environment may be generally square, generally rectangular, or any of a variety of other shapes depending on the area available for wastewater treatment. In one example, a small wastewater environment is 100 meters by 100 meters and a large installation is 500 meters in width and/or length. FIG. 22 shows a wastewater environment 440 that is larger than the environment 340 in FIG. 20. Platforms 442 are disposed on the surface of the wastewater.

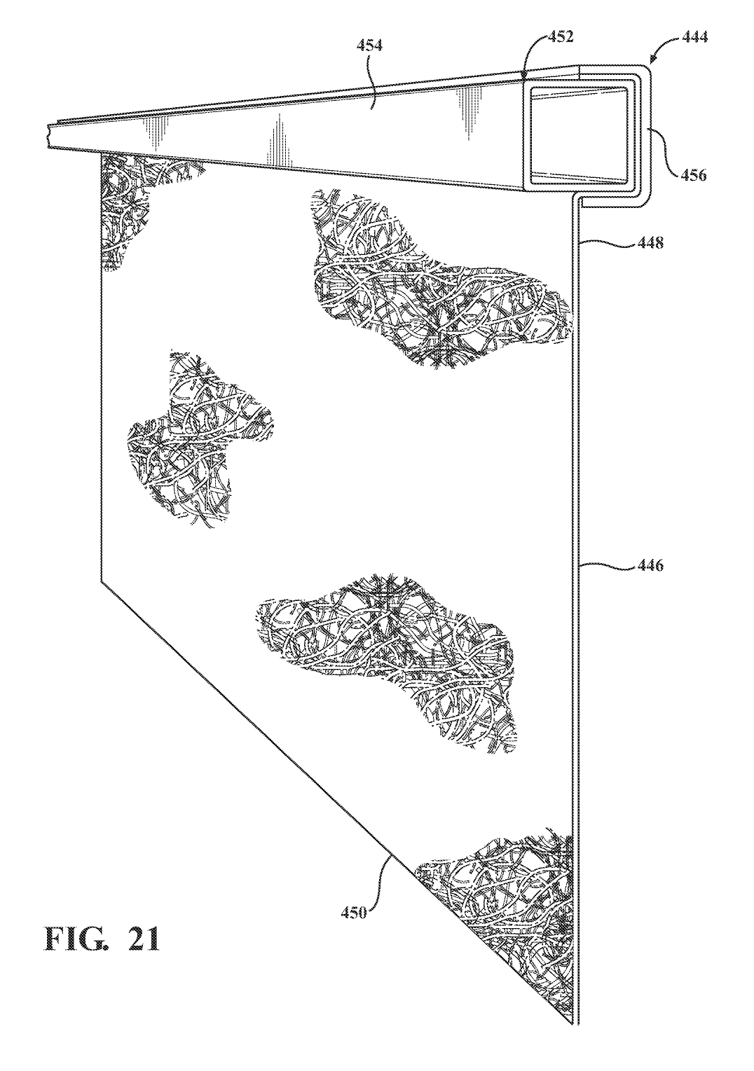

Some embodiments of the present invention utilize a different approach to hydraulic curtains. FIG. 21 shows a hydraulic curtain assembly 444 for use in the present invention. It includes a large body of curtain material 446, which may be similar to the material in FIG. 19. The curtain has an upper end 448 and a lower end 450. The hydraulic curtain assembly further has a floatation element 452 connected to the upper end 448 of the curtain 446. In the illustrated embodiment, the floatation element 452 is a square or rectangular hollow tube 454 with a C-shaped connecting piece 456 that engages a side of the tube 454 with curtain material trapped therebetween. The tube 454 would have sealed ends. The tube 454 may be of the same design as the element 305 in FIG. 18. The lower end 450 of the curtain may have weights or may be tethered or otherwise attached to the bottom or floor of the treatment zone.

Referring again to FIG. 22, two hydraulic curtain assemblies 444 are shown extending side to side in the wastewater environment 440. In a typical installation, many more curtain assemblies would be used, but they are left out of FIG. 22 to reduce visual clutter. Also, many more support structures 442 would be included, typically covering most or all of the surface of the wastewater environment. The hydraulic curtain assemblies are disposed between the support structures such that the structures are in the lanes defined by the curtain assemblies. The lanes defined by the curtains may extend side to side and/or end to end in the environment, or in other patterns. In some versions, the floatation elements for the hydraulic curtain assemblies may be one or more of the support structures 442. Additional biological curtains, which may be of the same material and may extend to different depths, are preferably included in the installation. An exemplary curtain 446 is shown perpendicular to the curtain 444 and another exemplary curtain 448 is shown parallel to the curtain 444. A mix of such curtains may be used.

In some wastewater treatment applications, the influent water parameters are so laden with chemical, or organic residuals, the plants upon platforms in a wastewater treatment facility would not survive if exposed for long. To address this issue, some versions of the present invention may use biological and/or hydraulic curtains without plants in part or all of the wastewater treatment zone. A biofilm is formed on these curtains and, with the help of atmospheric or injected oxygen, degrade these harmful substances before they proceed downstream. The installation may include support structures with aquatic plants, in accordance with any of the embodiments discussed above, downstream of the curtain-only support structures. Alternatively, an installation may include no plants, and rely only on curtain assemblies.

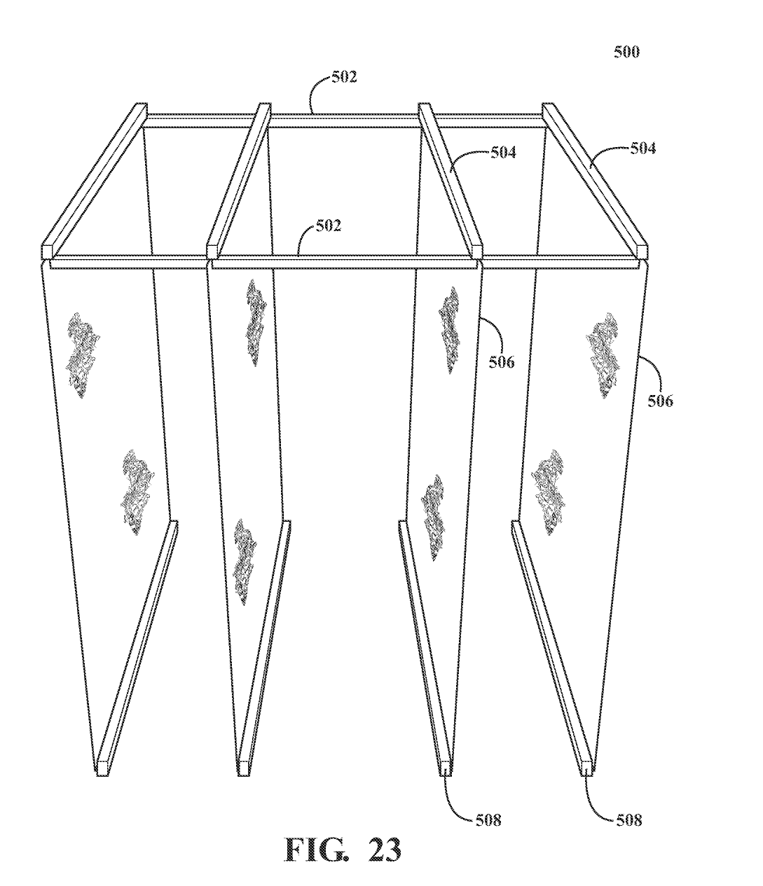

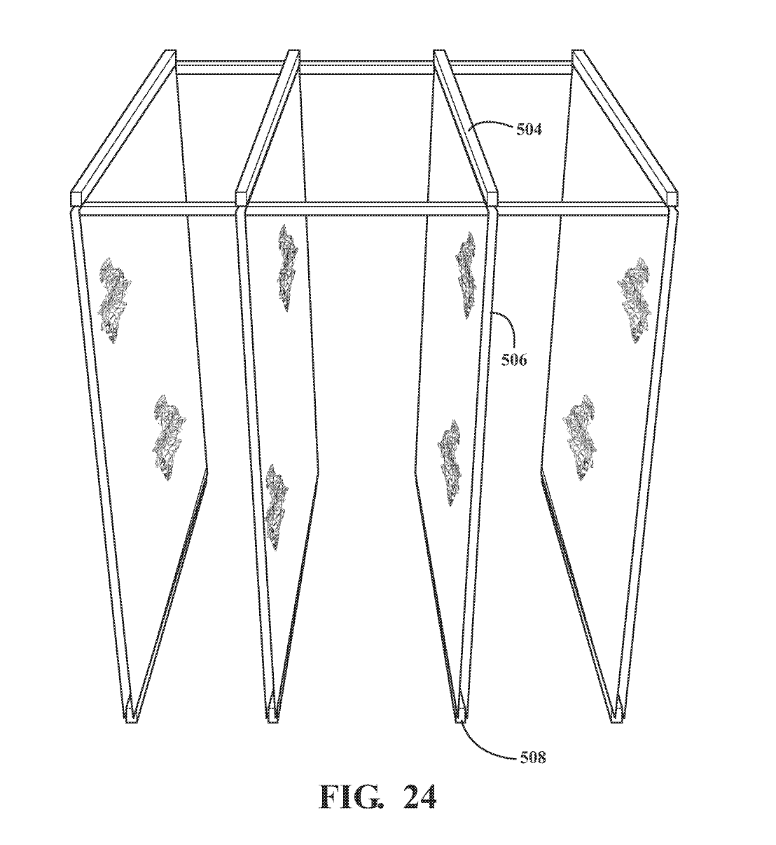

FIG. 23 is a perspective view of an alternative support structure and curtain assembly without plants, for use in an installation that lacks plants in all or part of the wastewater environment. The support structure 500 has elongated floatation members 502 that are spaced apart and generally parallel to each other. These act as a first stage member, and have buoyancy chambers defined therein. In some versions, the members are like the members 305 in FIG. 18. Curtain cross members 504 extend between and interconnect the floatation members 502. These may be part of a curtain assembly as shown in FIG. 21, and have a body of curtain material 506 attached thereto in the same manner or in other ways. A weight 508 may be provided at the lower end of each curtain 506 for maintaining it in position.

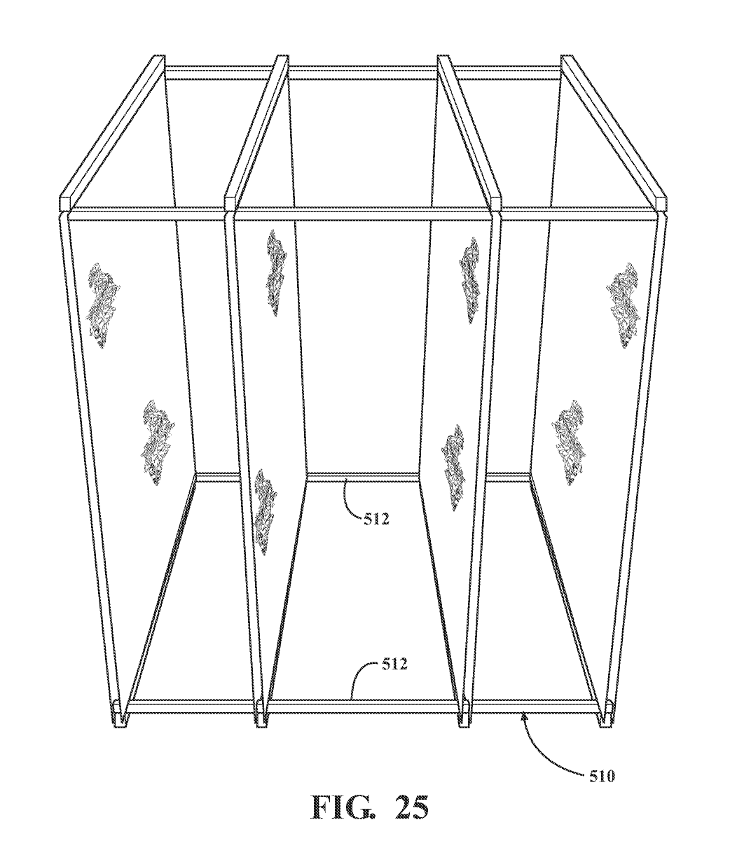

FIG. 24 is a perspective view of another version of the support structure and curtain assembly of FIG. 23. This version differs from the version of FIG. 23 in that the body of curtain material 506 is folded over the cross member so as to provide a portion hanging down both sides, to provide increased curtain surface area for biofilms. The lower ends of both portions of curtain material are attached to the weight 508.

FIG. 25 is a perspective view of a further version of the support structure and curtain assembly of FIG. 23. This version includes a bottom structure 510 having two bottom members 512. This bottom structure retains the lower ends of the curtains relative to each other. Additional structure may be provided.

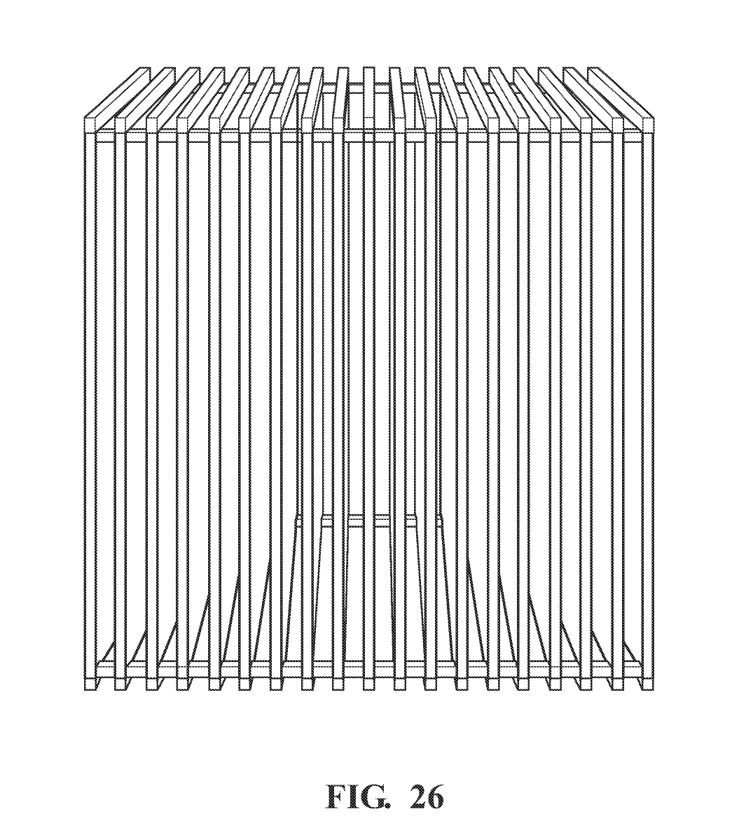

FIG. 26 is a perspective view of yet another version of the support structure and curtain assembly of FIG. 23. This version includes more curtain assemblies for a higher density of curtain material. The sheets of curtain material may be spaced apart by short distances, such as 8 cm, or as little as 2 cm. In some preferred embodiments, the sheets of curtain material are spaced apart by a distance in the range of 2 cm to 25 cm.

The embodiments of FIGS. 23-26 may further have plant supporting cross members, such as in earlier embodiments. Alternatively, the curtain assemblies of FIGS. 23-26 may be added to any of the earlier embodiments.

Some versions of the present invention may have a high density of hydraulic and biological curtains. For example, in some versions, some of the hydraulic curtains extend for a length greater than 20 meters, end to end, and have a length, top to bottom, great enough to extend at least 50% of the way to the bottom of the treatment zone. In some versions, some of the curtains extend for 80-100% of the depth. They may have a top to bottom length of at least 1 meter, or more than 2-3 meters. The hydraulic curtains may define lanes with a narrow width, including defining lanes narrower than one of the support structures. It is preferred that the lanes be at least 8 cm wide, and that there be at least an 8 cm gap between various curtains, to allow for the flow of water. However, in other embodiments, narrower gaps may be used, such as being as narrow as 2 cm. In some preferred embodiments, the sheets of curtain material are spaced apart by a distance in the range of 2 cm to 25 cm.

In any of the embodiments, the support structures may be anchored or restrained in a variety of ways. One approach is to use tethers or ropes to the area around the treatment zone or weighted to the bottom. Support structures and hydraulic curtain assemblies may also be connected to one another in various ways.

Preferred embodiments of the present invention are passive, in that no pumping of water or injection of oxygen is required for treatment of the wastewater. It should be noted that any of the aspects, elements or features of any of the embodiments discussed herein may be combined with any of the other aspects, elements or features of other embodiments in various ways to achieve treatment of wastewater.

As will be clear those of skill in the art, the illustrated and discussed embodiments of the present invention may be altered in various ways without departing from the scope or teaching of the present invention. It is the following claims, including all equivalents, which define the scope of the present invention.

1. A system for wastewater treatment using aquatic plants in a wastewater environment having an inlet and an outlet;
a wastewater treatment zone extending between an inlet and an outlet, the treatment zone having wastewater disposed therein and flowing into the treatment zone from the inlet and out of the treatment zone from the outlet, the wastewater treatment zone having first end and an opposed second end with a floor extending between the first and second ends, a depth being defined from a surface of the wastewater to the floor, the treatment zone having a plurality of depth zones continuous with one another, including at least;
a deep zone adjacent the first end of the treatment zone, the deep zone having a first depth;
a shallow zone adjacent the second end of the treatment zone, the shallow zone having a second depth less than the first depth; and
a portion of the floor of the treatment zone between the deep zone and the shallow zone sloping upwardly at an angle of at least 45 degrees;
a plurality of buoyant support structures disposed in the treatment zone for supporting aquatic plants in the wastewater environment, each support structure comprising:
a plurality of first stage members each having a buoyancy chamber defined therein, the first stage members defining a lower portion of the support structure and being spaced apart from one another; and
a plurality of elongated cross members disposed on top of the first stage members, the cross members extending between and interconnecting the first stage members, each cross member having a plurality of openings defined therein for receiving plants;
a plurality of hydraulic curtain assemblies each including a hydraulic curtain with an upper end and a lower part extending downwardly therefrom to a lower end, the assemblies each further including a floatation element connected to the upper end of the hydraulic curtain, the hydraulic curtain assemblies being disposed in the treatment zone such that the hydraulic curtains define a plurality of lanes in the wastewater environment;
a plurality of biological curtains each connected to one of the buoyant support structures, the biological curtain members comprising a body of material for formation of biofilms, the biological curtain members extending downwardly from the buoyant support structures into the lanes of the wastewater environment;
a first plurality of aquatic plants each disposed in one of the openings in the cross members, the plants being selected from the group of categories consisting of emergent macrophytes, floating leaf macrophytes, and submerged leaf macrophytes.

2. A system for wastewater treatment in accordance with claim 1, wherein the depth zones further include a medium zone disposed between the deep and shallow zones, the medium zone having a third depth greater than the second depth and less than the first depth;
the floor of the treatment zone between the deep zone and the medium zone sloping upwardly at an angle of at least 45 degrees; and
the floor of the treatment zone between the medium zone and the shallow zone sloping upwardly at an angle of at least 45 degrees.

3. A system for wastewater treatment in accordance with claim 1, wherein the buoyant support structures each further include at least one third stage member disposed above the first stage members, the at least one third stage member having a buoyancy chamber defined therein.

4. A system for wastewater treatment in accordance with claim 3, wherein the first and third stage members are elongated generally tubular hollow members.

5. A system for wastewater treatment in accordance with claim 3, wherein the first stage members are elongated members and are disposed generally parallel to each other, the elongated cross members being disposed generally parallel to each other and generally perpendicular to the first stage members.

6. A system for wastewater treatment in accordance with claim 1, wherein the elongated cross members each have a pair of elongated tubular side elements with a web extending therebetween, the openings for receiving plants being defined in the web, the tubular side elements each defining a buoyancy chamber.

7. A system for wastewater treatment in accordance with claim 1, wherein the hydraulic curtain assemblies extend side to side in the treatment zone, some of the hydraulic curtain assemblies extending from a first side of the treatment zone part way to a second side and some of the hydraulic curtain assemblies extending from the second side part way to the first side such that the hydraulic curtains define a plurality of back and forth lanes.

8. A system for wastewater treatment in accordance with claim 1, wherein the biological curtains and hydraulic curtains are sheets of the same material.

9. A system for wastewater treatment in accordance with claim 8, wherein the material is a non-woven mesh.

10. A system for wastewater treatment in accordance with claim 1, wherein the biological curtains extend generally parallel to the hydraulic curtains.

11. A system for wastewater treatment in accordance with claim 1, wherein the biological curtains extend generally perpendicular to the hydraulic curtains.

12. A system for wastewater treatment in accordance with claim 1, wherein the buoyant support structures are configured such that the elongated cross members, with the plants disposed in the openings therein, are disposed approximately at an upper surface of the wastewater environment.

13. A system for wastewater treatment in accordance with claim 1, further comprising plant holders received in the openings in the cross members, the plants being disposed in the plant holders.

14. A system for wastewater treatment in accordance with claim 1, wherein the floatation element of at least some of the hydraulic curtain assemblies are some of the buoyant support structures.

15. A system for wastewater treatment in accordance with claim 1, further comprising a plurality of support structure and curtain assemblies disposed in the wastewater treatment zone, the support structure and curtain assemblies having a plurality of floatation elements and a plurality of curtain assemblies attached thereto, and not having any plants supported thereon.

16. A system for wastewater treatment in accordance with claim 15, wherein the support structure and curtain assemblies without plants are disposed adjacent the inlet of the wasterwater treatment zone.

17-37. (canceled)

38. A system for wastewater treatment using aquatic plants in a wastewater environment having an inlet, an outlet and a treatment zone extending between the inlet and outlet, wastewater being disposed in the treatment zone and flowing into the treatment zone from the inlet and out of the treatment zone from the outlet, the system comprising:
a support structure having a first stage floatation structure and a second stage floatation structure, the first stage floatation structure supporting the second stage floatation structure above an upper surface of the wastewater when the support structure has small plants supported thereon.

39. (canceled)
